(19) United States
(12) Patent Application Publication
(10) Pub. No.: US 2014/0297435 A1
(43) Pub. Date: Oct. 2, 2014

(54) BANK CARD SECURED PAYMENT SYSTEM AND METHOD USING REAL-TIME COMMUNICATION TECHNOLOGY

(71) Applicant: Hoiling Angel WONG, Hong Kong (CN)

(72) Inventor: Hoiling Angel WONG, Hong Kong (CN)

(21) Appl. No.: 13/852,041

(22) Filed: Mar. 28, 2013

(51) Int. Cl. G06Q 20/40; G06Q 20/32

(52) U.S. Cl. CPC G06Q 20/409; G06Q 20/3223
USPC 705/21; 705/44

(57) ABSTRACT

A bank card secured payment system and method using real-time communication technology includes a bank card account and cellular phone, merchant's transaction terminal, payment network, account security server, wherein the account security server is equipped with real-time server end software for real-time communication technology. The cellular phone uses real-time communication application to connect to the account security server and links to the bank card. When the payment network receives transaction request relating to the bank card account from a merchant's transaction terminal the payment network performs a security verification process using real-time communication technology via the account security server and the user's cellular phone that is linked to the user's bank card account, which serves to authenticate the security verification of the user's identity, in which case the transaction request will proceed, otherwise the transaction request would be properly declined.

### BACKGROUND

The present invention relates to a financial payment technique, in particular to a bank card secured payment system and method using real-time communication technology.

Since bank cards are highly portable and easy-to-use, it provides a quick and convenient payment solution to card users, hence the use of bank cards has become increasingly popular, while it is common nowadays for consumers to possess more than one bank card. Although bank cards provides a quick and easy payment method, it brings about certain security issues as fraud perpetuators would attempt stealing others' bank card information through various means, then produce duplicate cards to carry out payment transactions, or use stolen card information to pay for online shopping. Generally, defrauded card users would only realize that their card information had been stolen for unauthorized purchases upon receiving monthly bank statements, the time of which would be too late as the fraud would have had already happened. The existence of a time lag between the detection and occurrence of bank card fraud is a problem to be solved. The present invention on a bank card secured payment system and method using real-time communication technology aims to assure the safety of bank cards and prevent users' bank card accounts from being compromised.

### SUMMARY

The object of the present invention is to provide a bank card secured payment system and method using real-time communication technology, thus realizing various applications of secured payment gateways.

The object of the present invention is achieved in such a way as described below: a bank card secured payment system, the characterization of which comprises users' bank card accounts and cellular phones (2), merchants' transaction terminal (3), payment network (4), account security server (5), wherein the account security server (5) and payment network (4) are connected through telecommunication network, the account security server (5) is equipped with a server end software for real-time communication technology, users' cellular phones (2) are equipped with real-time communication application, with which the cellular phone (2) uses to connect with the account security server (5) via cellular network, Wi-Fi network, and other wireless networks, the transaction terminal (3) connects to the payment network (4) through wired and/or wireless networks such as cellular network, Wi-Fi network, local area network (LAN), Internet and so on, the account security server (5) records the user bank card account information, each user's bank card account is respectively linked to the user's cellular phone (2), and when the payment network (4) receives transaction request relating to the user's bank card account from a merchant's transaction terminal (3), the payment network (4) authenticates the security verification of the user's identity, and the payment network (4) would only proceed with the remaining procedures to complete the transaction request after the security verification has succeeded, otherwise the transaction request would be properly declined.

In addition, a bank card secured payment method is adopted in the said bank card secured payment system, and the characterization of the said method comprises: setting up an account security server (5), recording users' bank card account information in said account security server (5), linking the user's' bank card account with the user's cellular phone (2), connecting the account security server (5) to the payment network (4) via telecommunication network, and the account security server (5) is equipped with real-time communication server end application, the cellular phone (2) is equipped with real-time communication application, through which the cellular phone (2) uses to connect to said account security server (5) via cellular network, Wi-Fi network, and other wireless networks, and when the payment network (4) receives the transaction request relating to the user's bank card account from merchant's transaction terminal (3), the payment network (4) authenticates the security verification of the user's identity, and the payment network (4) would only proceed with the remaining procedures to complete the transaction request after the security verification has succeeded, otherwise the transaction request would be properly declined.

As such, the object of the present invention is well achieved.

The payment system and method of the present invention ensures the safety of bank card accounts by instantaneously authenticating the user's identity through real-time communication with the user's cellular phone (2) upon the user's payment. Furthermore, the communication between the account security server (5) and the user's cellular phone (2) that is used to carry out the user identity verification procedure is ultimately independent of the transmission route taken by the original bank card network, thus even if a user's bank card account information has been stolen by fraud perpetrators, as long as the user has his/her cellular phone (2) in hand, these perpetrators would not succeed in their fraud scheme, thereby enhancing the safety of bank card accounts.

### BRIEF DESCRIPTION OF DRAWINGS

FIG. 1 is a schematic drawing of the structure of the first embodiment of the bank card secured payment system of the present invention;

FIG. 2 is a schematic drawing of the structure of the second embodiment of the bank card secured payment system of the present invention;

FIG. 3 is a schematic drawing of the structure of the third embodiment of the bank card secured payment system of the present invention;

FIG. 4 is a schematic drawing of the structure of the fourth embodiment of the bank card secured payment system of the present invention;

FIG. 5 is a schematic drawing of the structure of the fifth embodiment of the bank card secured payment system of the present invention;

FIG. 6 is a schematic drawing of the structure of the sixth embodiment of the bank card secured payment system of the present invention;

FIG. 7 is a schematic drawing of the structure of the seventh embodiment of the bank card secured payment system of the present invention;

FIG. 8 is a schematic drawing of the structure of the eighth embodiment of the bank card secured payment system of the present invention;

As shown in the figures, the same numerals represent the same system, means, component or device. The figures are exemplary and used for the purpose of illustrating the construction and main features of the present invention.

### DETAILED DESCRIPTION

The method of the present invention will be described in further detail below with reference to the drawings.

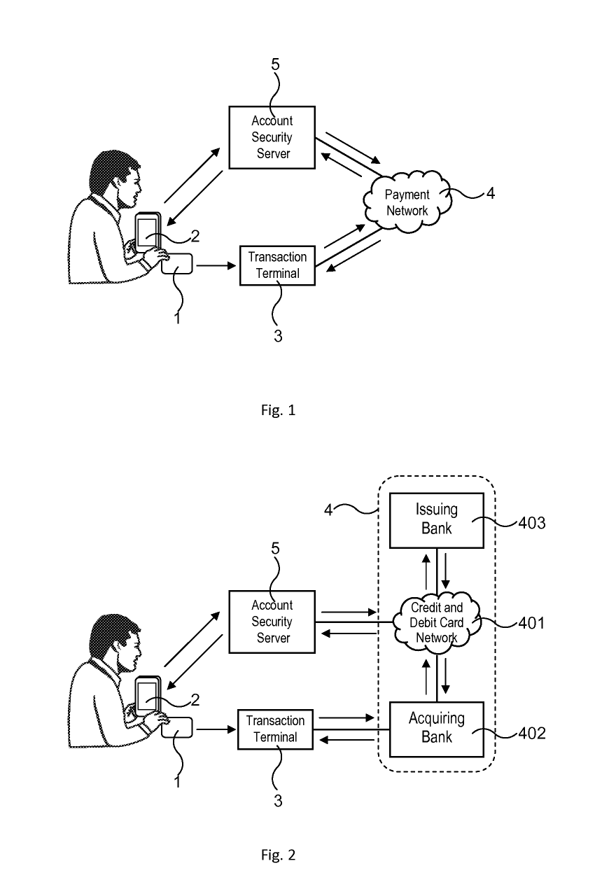

Referring to FIG. 1, which is a schematic drawing of the structure of the first embodiment of the bank card secured payment system of the present invention, the system in FIG. 1 comprises the user's bank card (1) and cellular phone (2), merchant's transaction terminal (3), payment network (4), account security server (5), wherein the account security server (5) and payment network (4) are connected through telecommunication networks, the account security server (5) is equipped with a server end software for real-time communication technology, the user's cellular phone (2) is equipped with real-time communication application, with which the cellular phone (2) uses to connect with the account security server (5) via cellular network, Wi-Fi network, and other wireless networks, the merchant's transaction terminal (3) connects to the payment network (4) through wired and/or wireless networks such as cellular network, Wi-Fi network, local area network (LAN), Internet and an on, the user is required to register his/her bank card account information and cellular phone (2) number in the account security server (5), which records the user's bank card account information and links the said information to the user's cellular phone (2), and When the user uses his/her bank card to process payment on the merchant's transaction terminal, upon receipt of transaction request relating to the user's bank card account transmitted from the merchant's transaction terminal, the payment network (4) authenticates the security verification of the user's identity through the account security server (5) and the cellular phone (2) that is linked to the user's respective bank account, and the payment network (4) would only proceed with the remaining procedures to complete the transaction request after the security verification has succeeded, otherwise the transaction request would be properly declined. Essentially, the present invention incorporates said account security server (5) to currently existing general bank card payment systems, and introduces the security authentication procedure of verifying user identity upon the user's payment, specifically, using real-time communication made between said account security server (5) and the user's cellular phone (2) to undergo security verification of the user's identity; after the security verification process is completed, the payment network (4) and merchant's transaction terminal (3) would still have to proceed with normal procedures that have not been executed; these normal procedures are referred to in the above-mentioned description as the remaining procedures that the payment network (4) have to complete transaction request upon successful security verification, which includes verifying user account balance, account credit limit, and so on. Since these regular procedures are duly carried out in existing bank card payment systems, these procedures are not attributes of the present invention, hence will not be described in detail in the present description.

Again, referring to FIG. 1, the method adopted by the said system shown in FIG. 1 comprises: setting up account security server (5), which records users' bank card account information and binds such information to the user's respective cellular phone (2), the account security server (5) and the payment network (4) are connected via telecommunication network, the account security server (5) is equipped with a server end software for real-time communication technology, users' cellular phones (2) are equipped with real-time communication application, with which the cellular phone (2) uses to connect with the account security server (5) via cellular network, Wi-Fi network, and other wireless networks, and when the payment network (4) receives the transaction request relating to the user's bank card account from merchant's transaction terminal (3), the payment network (4) authenticates the security verification of the user's identity through the account security server (5) and the cellular phone (2) that is linked to the user's bank card account, and the payment network (4) would only proceed with the remaining procedures to complete the transaction request after the security verification has succeeded, otherwise the transaction request would be properly declined.

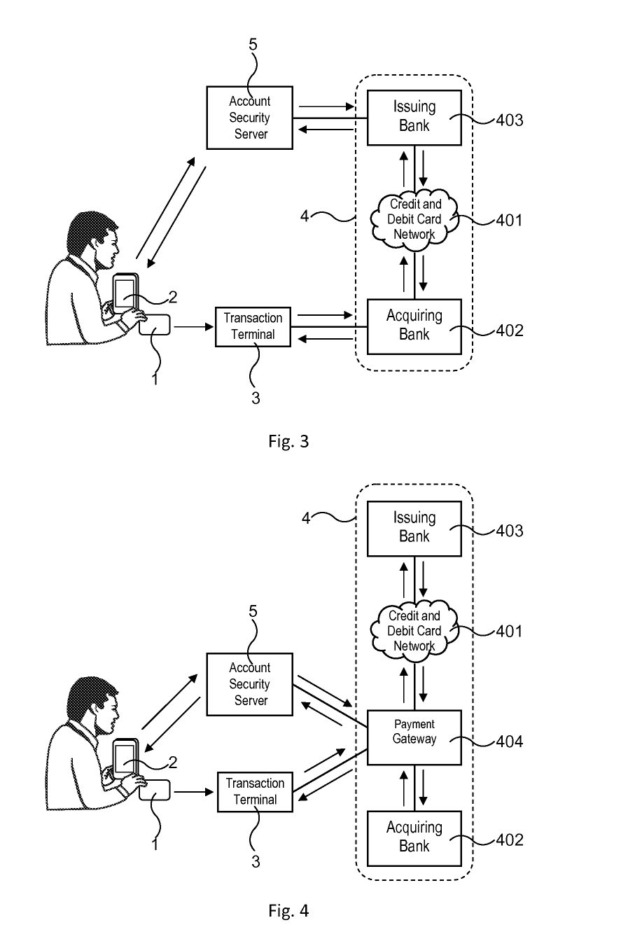

Referring to FIG. 2 to FIG. 4, in which FIG. 2 is a schematic drawing of the structure of the second embodiment of the bank card secured payment system of the present invention, FIG. 3 is a schematic drawing of the structure of the third embodiment of the bank card secured payment system of the present invention, and FIG. 4 is a schematic drawing of the structure of the fourth embodiment of the bank card secured payment system of the present invention, FIG. 2 to FIG. 4 illustrate the second, third, and fourth embodiment, respectively, and these figures depict examples of various types of payment network (4) that realize the object of the present invention, which is each described in further detail below.

Still referring to FIG. 2, the second embodiment of the payment network (4) comprises Credit and Debit card network (401), equipped with the acquiring bank (402) of merchants' bank card account and the issuing bank (403) of users' bank card account, wherein, the Credit and Debit card network (401) is linked to both the acquiring bank (402) and issuing bank (403) via telecommunication network, and is also linked to the said account security server (5) via telecommunication network, the transaction terminal (3) connects to the acquiring bank (402) of the payment network (4) via wired and/or wireless networks such as cellular network, Wi-Fi network, local area network (LAN), the Internet and so on, and when the Credit and Debit card network (401) processes transaction request relating to the user's bank card account, the said network undergoes a security authentication process to verify the user's identity via the account security server (5) and the cellular phone (2) associated to the user's bank card account. As shown in the second embodiment, the account security server (5) and Credit and Debit card network (401) are connected via telecommunication network, allowing the account security server (5) to be incorporated into the Credit and Debit card network (401), thereby making it possible for all transaction payment processed through the Credit and Debit card network (401) to also pass through the account security server (5) to undergo the security authentication process for user identity verification, which further strengthens the safety of bank card accounts.

Still referring to FIG. 3, the third embodiment of the payment network (4) comprises Credit and Debit card network (401), equipped with the acquiring bank (402) of merchants' bank card account and the issuing bank (403) of users' bank card account, wherein, the Credit and Debit card network (401) is linked to both the acquiring bank (402) and issuing bank (403) via telecommunication network, the issuing bank (403) and the said account security server (5) are connected via telecommunication network, the transaction terminal (3) is connected to the payment network of the acquiring bank (402) via wired and/or wireless networks such as cellular network, Wi-Fi network, local area network (LAN), the Internet, and no on, and when the issuing bank (403) processes transaction request relating to the user's bank card account, the issuing bank (403) undergoes a security authentication process to verify the user's identity via the account security server (5) and the cellular phone (2) associated to the user's bank card account. As shown in the third embodiment, the account security server (5) and the issuing bank (403) are connected via telecommunication network, allowing the account security server (5) to be incorporated into the issuing bank (403), thereby making it possible for all transaction payment processed through the issuing bank (403) to also pass through the account security server (5) to undergo the security authentication process for user identity verification, which further strengthens the safety of bank card accounts.

Still referring to FIG. 4, the fourth embodiment of the payment network (4) comprises Credit and Debit card network (401), equipped with the acquiring bank (402) of merchants' bank card account and the issuing bank (403) of users' bank card account, and payment gateway (404), wherein, the Credit and Debit card network (401) is connected to the issuing bank (403) via telecommunication network, the payment gateway (404) is connected to both the acquiring bank (402) and Credit and Debit card network (401), as well as the said account security servers (5) via telecommunication network, the transaction terminal (3) is connected to the payment gateway (404) of the payment network (4) via wired and/or wireless networks such as cellular network, Wi-Fi network, local area network (LAN), the Internet, and so on, and when the payment gateway (404) processes transaction request relating to the user's bank card account, the payment gateway (404) undergoes a security authentication process to verify the user's identity via the account security server (5) and the cellular phone (2) associated to the user's bank card account. As shown in the fourth embodiment, the payment network (4) comprises the payment gateway (404), which provides network services to merchants' transaction terminal (3) and acquiring bank (402), the structure of which is common among many existing credit card payment systems.

The second to fourth embodiments of the present invention are described in detail above. The object of the present invention is well achieved, regardless of which of the second, third, or fourth embodiment is utilized in the payment network (4), hence the use of any one of the second, third, or fourth embodiment belongs to the protected area of the present invention.

In the above description, the said Credit and Debit card network (401) includes receiving bank card networks of Visa, China UnionPay, MasterCard, American Express, Japan Credit Bureau, Diners Club International, and so on, all of which can be well applied to the present invention. Furthermore, in the above description, the said transaction terminal (3) refers to devices that can generate payment transactions, including merchant point-of-sale machines generally used for receivables, swipe machines that accept credit and debit cards, card readers for contactless debit cards, and no on. The said transaction terminal (3) can also refer to a computer, or server, such as a server for online shopping websites, a server providing telephone and television shopping services, a public institution's account server for processing automatic transfer payments, a bank ATM, or a computer generating payment through online banking, all of which are referred to as transaction terminal (3) in this manual. Furthermore, the said bank card in the above description includes credit cards, debit cards, charge cards, secured cards, and all other cards that banks issue for payment and transactions, all of which are referred to as bank cards (1) in this manual. Furthermore, the said cellular phone (2) can refer to any apparatus that is capable of performing communication, such as smartphones, tablet computers, personal digital assistant (PDA), and all other electronic devices that can perform wireless communication through networks, all of which are referred to as cellular phone (2).

The primary characteristic of the present invention is through the real-time communication between the account security server (5) and users' cellular phone (2), the account security server (5) is able to perform a security authentication process, in which the said server can assign and perform different levels of security verification in accordance to the risk level and payment amount of the transaction. The different levels of security verification are described in further detail below.

Small-amount payments can allow for relatively simpler security verification, such as whether the cellular phone (2) that is being verified by the account security server (5) has successfully connected to the said server (5), in which case if the cellular phone (2) is successful, then the security verification is completed; otherwise, the security verification would fail. The user can perform small-amount payments, as long as the user's cellular phone (2) is in power-on mode and has successfully connected into the account security server (5). Furthermore, the security verification can be performed by means of a reminder message, which includes transactional information and is sent upon the user's payment to the user's cellular phone (2) via the account security server (5), in which case if the reminder message is successfully sent to the user's cellular phone, then the security verification is completed; otherwise, the security verification would fail. The security verification is considered complete when the user's cellular phone (2) receives the reminder message, which informs the user of a payment transaction by the user's bank card account. In the case that the user receives a reminder message without undergoing any payment transaction, the user can immediately report the possible bank card fraud to the bank or police authorities to minimize any loss incurred.

Besides of the relatively simpler security verification mentioned above, larger payment amounts can utilize a higher level security authentication, which requires the user to pre-set a message used for confirmation in the account security server (5), which can be a password or a dynamic message. Under this higher level security authentication, when the user uses his/her bank card to process payment, the account security server (5) will first send a reminder message related to the transaction to the user's cellular phone (2), then the said server (5) will verify the confirmation message sent back from the user's cellular phone (2), in which case if the account security server (5) receives a correct and valid confirmation message, the security verification is completed; otherwise, the security verification would fail, hence even if a user's cellular phone (2) and bank card (1) were both stolen, fraud perpetrators still lack the correct confirmation message to successfully perform large-amount payment transactions, which greatly enhances the safety of bank card accounts.

Larger payment amounts can also utilize a more sophisticated security verification procedure, which is to request users to answer some personal questions to verify the user's identity. To perform this security verification process, the said account security server (5) needs to store the user's personal information, such as the user's full name, age, address, contact number, hobbies, occupation, company name and address, history of recent bank card transactions, as well as other personal information of the user's family and close relatives. As such, during the security verification process, the account security server (5) can generate a message consisting of one or multiple verifying question(s) based on random selection of any stored personal information of the user, then transmit these verifying question(s) to the user's cellular phone (2) and requests the user to respond with a message containing respective answer(s) to the verifying question(s) and send such message to the account security server (5) in a specified timeframe (e.g. within 15 seconds) from the user's receipt time of the verifying question(s). The account security server (5) will then process the user's response and verify the answer(s) received against the stored information of the user, in which case if all verifying question(s) are successfully authenticated, the security verification is successful; otherwise, the security verification would fail. For example, these personal verifying questions can be “What is the city you were born in,” or “What is the occupation of your spouse,” to which the user has to correctly to pass the security verification procedure. In addition, these verifying questions can be presented in the form of multiple-choice, where users are given multiple answers to choose from, making it easier for users to respond quickly to the verifying question(s).

The present invention and method can utilize only one of the different levels of security verification described above, or apply the said verification procedures entirely or partially, and determine the appropriate level of security verification bass on the risk level and payment amount. For example, small-amount payment transactions require simpler verification procedures in connecting the cellular phone (2) to the account security server (5); larger payment amounts require users to respond with a correct confirmation message via the cellular phone (2); online payment transactions, given the high risk in the nature of online shopping, require the user to respond via the user's cellular phone (2) a correct confirmation message and valid answers to multiple verifying questions for the security authentication to be completed. The object of the present invention is well achieved regardless of which of the said security verification level is utilized, hence the use of any one of the said verification level belongs to the protected area of the present invention.

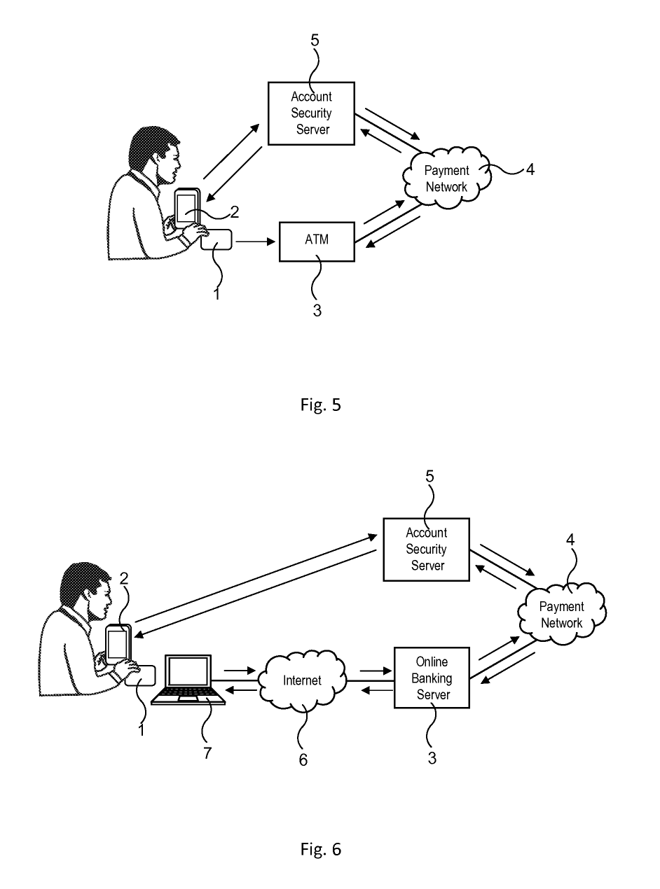

Referring to FIG. 5, which is a schematic drawing of the structure of the fifth embodiment of the bank card secured payment system of the present invention, the figure illustrates the application and implementation of the present invention in ATM withdrawal machines. In the fifth embodiment, the transaction terminal (3) is the bank's ATM withdrawal machine, and the payment network (4) is equipped with the bank of the user's bank card (1) account and the bank's ATM network, hence when users use their bank cards to perform transactions in ATM withdrawal machines, such as withdrawals, transfers, and other disbursement activities, the payment network (4) immediately authenticates the security verification of the user's identity via the account security server (5) and the cellular phone (2) associated to the user's bank card account, in which case the transaction can proceed only when the security verification is completed; otherwise, the security verification would fail.

Referring to FIG. 6, which is a schematic drawing of the structure of the sixth embodiment of the bank card secured payment system of the present invention, the figure illustrates the application and implementation of the present invention in online banking services. In the sixth embodiment, the said transaction terminal (3) is the online banking server, and the user can utilize computers (7) with online capabilities to perform account operations, such as transfer funds, remit payments, purchase stocks, and other disbursement activities, via the Internet that is connected to the online banking server, which generates transactional information based on the user's account operations and submits respective transaction requests to the payment network (4), which in turn requests the user's bank card account to perform payment, enabling the payment network (4) to immediately authenticate the user identity's security verification via the account security server (5) and the cellular phone (2) that is associated to the user's bank card account, in which case the transaction payment can proceed and the online banking server can carry out account operations only when the security verification is completed; otherwise, the payment network (4) would reject payment of the transaction, thereby the online banking server would not be able to carry out account operations. Compared to existing general online banking systems, the system shown in the sixth embodiment allows users to manage the security of their bank card accounts with their cellular phones (2), so even if hackers had stolen a user's bank card account information, the hackers would still fail to commit online banking fraud if they lacked the user's cellular phone (2) that is associated to the user's bank account.

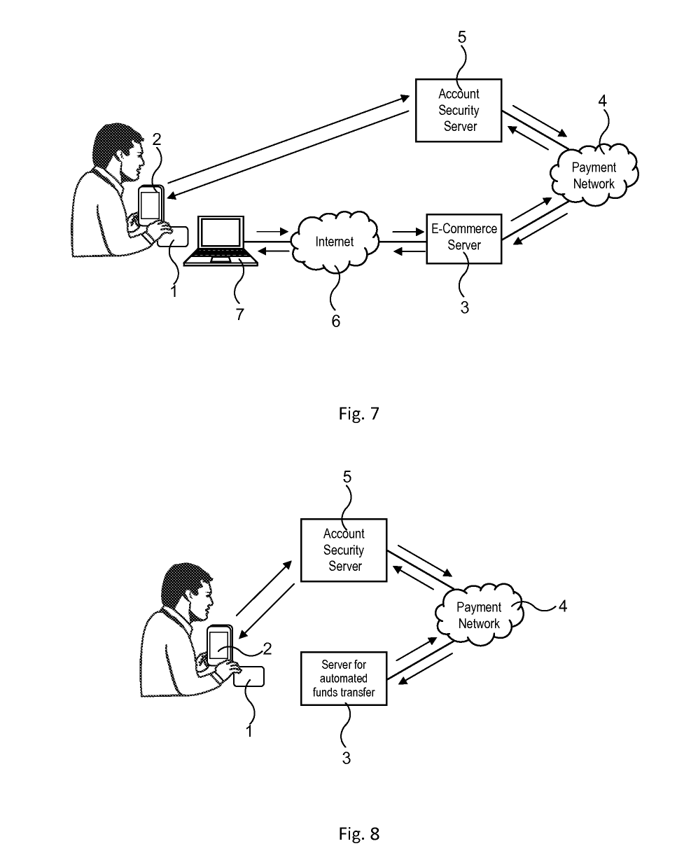

Referring to FIG. 7, which is a schematic drawing of the structure of the seventh embodiment of the bank card secured payment system of the present invention, the figure illustrates the application and implementation of the present invention in online shopping. In the seventh embodiment, the said transaction terminal (3) is an e-commerce server for online stores, such as shopping websites, online malls, software websites, music sites, movie websites, and all other online retailers that sells goods, software, services, entertainment, and so on. When the user uses an Internet terminal (7) to login to the e-commerce server, which is essentially the transaction terminal (3), via the Internet (6) and generates a purchase order, the e-commerce server will generate relative transactional information based on the user's purchase order and submits transaction request to the payment network (4) for the user's bank account to perform payment, to which the payment network (4) would immediately perform the security verification procedures to authenticate the user's identity via the account security server (5) and the cellular phone (2) that is associated to the user's bank card account, in which case the payment network (4) can proceed with the payment of the purchase transaction only when the security verification is completed; otherwise, the payment network (4) would reject the payment of the purchase. Furthermore, the seventh embodiment applies to electronic merchants involved in television and telephone shopping, where upon the user's payment for their purchases, the payment network (4) would immediately perform the security verification procedures to authenticate the user's identity via the account security server (5) and the cellular phone (2) that is associated to the user's bank card account, in which case the payment network (4) can proceed with the payment of the purchase transaction only when the security verification is completed; otherwise, the payment network (4) would reject the payment of the purchase.

Referring to FIG. 8, which is a schematic drawing of the structure of the eighth embodiment of the bank card secured payment system of the present invention, the figure illustrates the application and implementation of the present invention in automated funds transfers. In the eighth embodiment, the said transaction terminal (3) is the server for the account systems of automated funds transfers used in public institutions like power, gas, and telecommunication companies, which are regularly used to transfer funds and remit payments from users' bank accounts. Although automated funds transfer is fast and convenient, many bills using automated transfers are not fixed charges as the amount due is usually based on volume, hence most users do not know the exact amount transferred from their bank account until after they receive their monthly bills, when the amount due would have already been paid by automated transfer, which poses an issue to many users who are concerned about being overcharged, hindering the widespread implementation of automated funds transfer. In the eighth embodiment, when the server for the account system of automated funds transfers, or transaction terminal (3), requests the bank, or payment network (4), to automatically transfer funds from the user's bank card account for bill payment purposes, such as when power companies prompts to automatically transfer the user's electricity charges for the month from the user's bank card account, the payment network (4) would immediately perform the security verification procedures to authenticate the user's identity via the account security server (5) and the cellular phone (2) that is associated to the user's bank card account, in which case the payment network (4) can proceed with the payment of the purchase transaction only when the security verification is completed; otherwise, the payment network (4) would reject the payment of the purchase. Through security verification procedures, the eighth embodiment allows users to completely manage all automated funds transfer activities, so users won't need to worry about being overcharged, which also helps the widespread implementation of automated funds transfer.

The features of the present invention have been described above in detail; although the present invention is described using the above-mentioned embodiments, the present invention is not limited to the embodiments described, hence various changes and variations can be made without departing from the present invention and the scope of the appended claims.

The bank card secured payment system and method using real-time communication described in the present invention enhances the security of bank card accounts and protects the interests of bank card users. The implementation of the present invention will be beneficial to the bank and bank users.

We claim:

1. A bank card secured payment system, the characterization of which comprises users' bank card accounts and cellular phones (2), merchants' transaction terminal (3), payment network (4), account security server (5), wherein the account security server (5) and payment network (4) are connected through telecommunication network, the account security server (5) is equipped with a server end software for real-time communication technology, users' cellular phones (2) are equipped with real-time communication application, with which the cellular phone (2) uses to connect with the account security server (5), the transaction terminal (3) connects to the payment network (4), the account security server (5) records the user bank card account information, each user's bank card account is respectively linked to the user's cellular phone (2), and when the payment network (4) receives transaction request relating to the user's bank card account from a merchant's transaction terminal (3), the payment network (4) authenticates a security verification of the user's identity through the real-time link between the account security server (5) and the cellular phone (2), and the payment network (4) would only proceed with the remaining procedures to complete the transaction request after the security verification has succeeded, otherwise the transaction request would be properly declined.

2. The bank card secured payment system as described in claim 1, characterized by that the said payment network (4) comprises Credit and Debit card network (401), equipped with the acquiring bank (402) of merchants' bank card account and the issuing bank (403) of users' bank card account, wherein, the Credit and Debit card network (401) is linked to both the acquiring bank (402) and issuing bank (403) via telecommunication network, and is also linked to the said account security server (5) via telecommunication network, the transaction terminal (3) connects to the acquiring bank (402) of the payment network (4), and when the Credit and Debit card network (401) processes transaction request relating to the user's bank card account, the said network undergoes a security authentication process to verify the user's identity via the account security server (5) and the cellular phone (2) associated to the user's bank card account.

3. The bank card secured payment system as described in claim 2, characterized by that the said Credit and Debit card network (401) includes the receiving bank card networks of Visa, China UnionPay, MasterCard, American Express, Japan Credit Bureau, and Diners Club International.

4. The bank card secured payment system as described in claim 1, characterized by that the said payment network (4) comprises Credit and Debit card network (401), equipped with the acquiring bank (402) of merchants' bank card account and the issuing bank (403) of users' bank card account, wherein, the Credit and Debit card network (401) is linked to both the acquiring bank (402) and issuing bank (403) via telecommunication network, the issuing bank (403) and the said account security server (5) are connected via telecommunication network, the transaction terminal (3) is connected to the payment network of the acquiring bank (402), and when the issuing bank (403) processes transaction request relating to the user's hank card account, the issuing bank (403) undergoes a security authentication process to verify the user's identity via the account security server (5) and the cellular phone (2) associated to the user's bank card account.

5. The bank card secured payment system as described in claim 4, characterized by that the said Credit and Debit card network (401) includes the receiving bank card networks of Visa, China UnionPay, MasterCard, American Express, Japan Credit Bureau, and Diners Club International.

6. The bank card secured payment system as described in claim 1, characterized by that the said payment network (4) comprises Credit and Debit card network (401), equipped with the acquiring bank (402) of merchants' bank card account and the issuing bank (403) of users' bank card account, and payment gateway (404), wherein, the Credit and Debit card network (401) is connected to the issuing bank (403) via telecommunication network, the payment gateway (404) is connected to both the acquiring bank (402) and Credit and Debit card network (401), as well as the said account security servers (5) via telecommunication network, the transaction terminal (3) is connected to the payment gateway (404) of the payment network (4), and when the payment gateway (404) processes transaction request relating to the user's bank card account, the payment gateway (404) undergoes a security authentication process to verify the user's identity via the account security server (5) and the cellular phone (2) associated to the user's bank card account.

7. The bank card secured payment system as described in any one of claim 6, characterized by that the said Credit and Debit card network (401) includes the receiving bank card networks of Visa, China UnionPay, MasterCard, American Express, Japan Credit Bureau, and Diners Club International.

8. The bank card secured payment system as described in claim 1, characterized by that the said transaction terminal (3) is bank's ATM withdrawal machine.

9. The bank card secured payment system as described in claim 1, characterized by that the said transaction terminal (3) is online banking server.

10. The bank card secured payment system as described in claim 1, characterized by that the said transaction terminal (3) is e-commerce server for online stores.

11. The bank card secured payment system as described in claim 1, characterized by that the said transaction terminal (3) is account system for automated funds transfer.

12. A bank card secured payment method, which is characterized by that the said method comprises:
setting up an account security server (5),
recording users' bank card account information in said account security server 5,
linking the user's' bank card account with the user's cellular phone (2),
connecting the account security server (5) to the payment network (4) via telecommunication network, and the account security server (5) is equipped with real-time communication server end application, the cellular phone (2) is equipped with real-time communication application, through which the cellular phone (2) uses to connect to said account security server (5), and when the payment network (4) receives the transaction request relating to the user's bank card account from merchant's transaction terminal (3), the payment network (4) authenticates a security verification of the user's identity through the account security server (5), wherein the account security server (5), executing the real-time communication server end application, establishes a real-time link with the cellular phone, executing the real-time communication application, to authenticate the security verification of the user's identity (2) and the payment network (4) would only proceed with the remaining procedures to complete the transaction request after the security verification has succeeded, otherwise the transaction request would be properly declined.

13. The bank card secured payment method as described in claim 12, characterized by that the said account security server (5) stores users' personal information, and when the said server (5) performs security verification, the account security server (5) randomly selects any of the stored personal information to generate verifying question(s), which will then be sent to the respective user's cellular phone (2), and the user has to respond with a message containing answer(s) to the verifying question(s) in a specified timeframe, and the account security server (5) will then process the user's response and verify the answer(s) received, in which case if all verifying question(s) are successfully authenticated, the security verification is successful; otherwise, the security verification would fail.

14. The bank card secured payment method as described in claim 12, characterized by that the said security verification process includes the transmission of reminder message containing transactional information from the account security server (5) to the user's cellular phone (2), in which case if the reminder message is successfully sent to the user's cellular phone (2), the security verification is completed; otherwise, the security verification would

15. The bank card secured payment method as described in claim 14, characterized by that the said account security server (5) stores users' personal information, and when the said server (5) performs security verification, the account security server (5) randomly selects any of the stored personal information to generate verifying question(s), which will then be sent to the respective user's cellular phone (2), and the user has to respond with a message containing answer(s) to the verifying question(s) in a specified timeframe, and the account security server (5) will then process the user's response and verify the answer(s) received, in which case if all verifying question(s) are successfully authenticated, the security verification is successful; otherwise, the security verification would fail.

16. The bank card secured payment method as described in claim 13, characterized by that the said security verification process includes the account security server (5) verifying the confirmation message sent from the user's cellular phone (4 in which case if the account security server (5) receives a correct and valid confirmation message, the security verification is completed; otherwise, the security verification would fail.

17. The bank card secured payment method as described in claim 16, characterized by that the said account security server (5) stores users' personal information, and when the said server (5) performs security verification, the account security server (5) randomly selects any of the stored personal information to generate verifying question(s), which will then be sent to the respective user's cellular phone (2), and the user has to respond with a message containing answer(s) to the verifying question(s) in a specified timeframe, and the account security server (5) will then process the user's response and verify the answer(s) received, in which case if all verifying question(s) are successfully authenticated, the security verification is successful; otherwise, the security verification would fail.

18. The bank card secured payment system as described in claim 12, characterized by that the said transaction terminal (3) is one of a bank's ATM withdrawal machine and an online banking server.

19. The bank card secured payment system as described in claim 12, characterized by that the said transaction terminal (3) is e-commerce server for online stores.

20. The bank card secured payment system as described in claim 12, characterized by that the said transaction terminal (3) is account system for automated funds transfer.
